(19) United States
(12) Patent Application Publication
(10) Pub. No.: US 2014/0079516 A1
(43) Pub. Date: Mar. 20, 2014

(54) Transportation Device of Glass Substrate Cartridges and Warehouse Apparatus

(71) Applicants: Zenghong Chen, Shenzhen City (CN); Chunhao Wu, Shenzhen City (CN); Kunhsien Lin, Shenzhen City (CN); Minghu Qi, Shenzhen City (CN); Zhenhua Guo, Shenzhen City (CN); Weibing Yang, Shenzhen City (CN)

(72) Inventors: Zenghong Chen, Shenzhen City (CN); Chunhao Wu, Shenzhen City (CN); Kunhsien Lin, Shenzhen City (CN); Minghu Qi, Shenzhen City (CN); Zhenhua Guo, Shenzhen City (CN); Weibing Yang, Shenzhen City (CN)

(21) Appl. No.: 13/642,536

(22) PCT Filed: Sep. 24, 2012
(86) PCT No.: PCT/CN12/81818

§ 371 Date: Oct. 21, 2012

(30) Foreign Application Priority Data
Sep. 19, 2012 (CN) 201210349258.3

(51) Int. Cl. B65D 19/22; B65G 1/04

(52) U.S. Cl. 414/298; 248/346.04

(57) ABSTRACT

A transportation device of the glass substrate cartridges and a warehouse apparatus are disclosed. The transportation device includes supporting components for bearing the glass substrate cartridges, and positioning components arranged on the supporting components for elastically positioning the glass substrate cartridges along a horizontal direction. The glass substrates within the glass substrate cartridges are not displaced or fragmented due to the buffering effect between the glass substrate cartridges and the positioning components.

### BACKGROUND OF THE INVENTION

1. Field of the Invention

Embodiments of the present disclosure relate to display technology, and more particularly to a transportation device of the glass substrate cartridges and a warehouse apparatus.

2. Discussion of the Related Art

Glass substrates are usually temporality stored by glass substrate cartridges in liquid crystal device manufacturing. And the glass substrate cartridges are stored in a serial of warehouse apparatuses forming an automatic transportation system.

Each warehouse apparatus includes cabinets, lifting arms, and transportation devices. The transportation devices connect with the lifting arms and are driven by the lifting arms to move the glass substrate cartridges into the cabinets.

In conventional technology, the transportation device includes bearing arms and positioning mechanisms. In the transportation process, the transportation device moves close to the glass substrate cartridges and then lifts the glass substrate cartridges. The bearing arms hold the glass substrate cartridges and pass through the positioning mechanisms to prevent the glass substrate cartridges from falling in a predetermined direction or in a direction opposite to the predetermined direction.

However, in the above process, the glass substrate cartridges contact the positioning mechanisms rigidly. The glass substrate cartridges collide with the positioning mechanisms when the transportation speed is high or a transportation deviation happens. Such collisions may result in the displacement or fragment of the glass substrates.

### SUMMARY

The object of the claimed invention is to provide a transportation device of the glass substrates and a warehouse apparatus. The transportation device is capable of reducing a fragment rate of the glass substrates.

In one aspect, a transportation device of glass substrate cartridge includes at least two supporting components for bearing the glass substrate cartridges, at least one pair of positioning components arranged on the supporting component, and connecting components. The two supporting components extend along a first horizontal direction and are spaced apart from each other in a second horizontal direction, and wherein the second horizontal direction is vertical to the first horizontal direction. The positioning components extend along the first horizontal direction and are spaced apart from each other, and the at least one pair of positioning components elastically position the glass substrate cartridges along the first horizontal direction. The connecting components extend along the second horizontal direction and connect the at least two supporting components.

Wherein the glass substrate cartridges includes at least two supporting bars arranged in a bottom of the glass substrate cartridges, the supporting bars extend along the second horizontal direction and are spaced apart from each other in the first horizontal direction, and each pair of the positioning components elastically grip two opposite sides of the supporting bars along the first horizontal direction.

Wherein the positioning components include a fixing assembly, an elastic assembly and a sliding assembly arranged on the supporting component along the first horizontal direction, the fixing assembly is fixed on the supporting component, the sliding assembly is capable of sliding along with the supporting component, and the elastic assembly is arranged between the fixing assembly and the sliding assembly so that the sliding assembly is elastically supported on the gripped side of the supporting bars.

Wherein the sliding assembly includes a guiding portion for guiding the glass substrate cartridges to be carried on the supporting component along a vertical direction.

Wherein the guiding portion includes an arc-connected surface.

Wherein the elastic assembly is a spring.

In another aspect, a transportation device of glass substrate cartridges includes at least one supporting component for bearing the glass substrate cartridges, and at least one pair of positioning components arranged on the supporting component. The positioning components elastically position the glass substrate cartridges along a horizontal direction.

Wherein the transportation device includes at least two supporting components extending along a first horizontal direction and are spaced apart from each other in a second horizontal direction, wherein the second horizontal direction is vertical to the first horizontal direction, and the positioning components elastically position the glass substrate cartridges along the first horizontal direction.

Wherein the transportation device includes at least one pair of positioning components extending along the first horizontal direction, the positioning components are spaced apart from each other, and each pair of positioning components elastically position the glass substrate cartridges along the first horizontal direction.

Wherein the glass substrate cartridges include at least two supporting bars arranged in a bottom of the glass substrate cartridges, the supporting bars extend along the second horizontal direction and are spaced apart from each other in the first horizontal direction, and each pair of the positioning components elastically grip two opposite sides of the supporting bars along the first horizontal direction.

Wherein the positioning components include a fixing assembly, an elastic assembly and a sliding assembly arranged on the supporting component along the first horizontal direction, the fixing assembly is fixed on the supporting component, the sliding assembly is capable of sliding along with the supporting component, and the elastic assembly is arranged between the fixing assembly and the sliding assembly so that the sliding assembly is elastically supported on the gripped side or the supporting bars.

Wherein the sliding assembly includes a guiding portion for guiding the glass substrate cartridges to be carried on the supporting component along a vertical direction.

Wherein the guiding portion includes an arc-connected surface.

Wherein the elastic assembly is a spring.

Wherein the transportation device further includes connecting components extending along the second horizontal direction and connecting the at least two supporting components.

In another aspect, a warehouse apparatus includes a cabinet, lifting arms, and a transportation device. The transportation device includes at least one supporting component and at least one pair of positioning components arranged on the supporting component. The at least one supporting component is for bearing the glass substrate cartridges, and the at least one pair of positioning components is for elastically positioning the glass substrate cartridges along a horizontal direction. The transportation device connects with the lifting and is driven by the lifting arms to move the glass substrate cartridges into the cabinet or to move glass substrate cartridges out from the cabinet.

### BRIEF DESCRIPTION OF THE DRAWINGS

FIG. 1 is a space diagram of the transportation device of the glass substrate cartridges in accordance with one embodiment.

FIG. 2 is a top view of the transportation device of

FIG. 3 is a space diagram of the transportation device of FIG. 1.

FIG. 4 is a space diagram of the warehouse apparatus in accordance with one embodiment.

### DETAILED DESCRIPTION OF THE EMBODIMENTS

Embodiments of the invention will now be described more fully hereinafter with reference to the accompanying drawings, in which embodiments of the invention are shown.

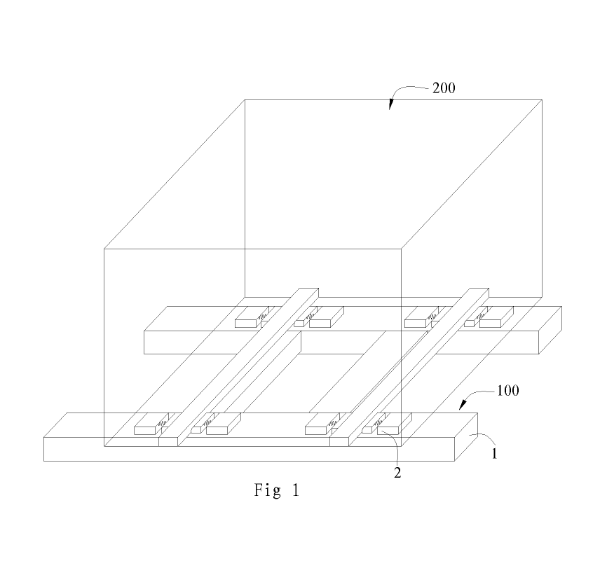

As shown in FIG. 1, a transportation device 100 of glass substrate cartridges 200 includes at least one supporting component 1 and at least one pair of positioning components 2. The supporting component 1 is for hearing the glass substrate cartridges 200. The positioning components 2 are arranged above the supporting component 1 to elastically position the glass substrate cartridges 200 along a horizontal direction.

In one embodiment, the transportation device 100 includes two supporting component 1, wherein one of the supporting component 1 extends along the first horizontal direction X. The supporting components 1 are spaced apart from each other in the second horizontal direction Y. The supporting component 1 is substantially bar-shaped. The transportation device 100 accesses the glass substrate cartridges 200 along the first horizontal direction X. The positioning components 2 elastically positions the glass substrate cartridges 200 along the first horizontal direction X to prevent the glass substrate cartridges 200 from falling from the transportation device 100.

The transportation device 100 may include, but not limited to, one or three supporting components 1. In one embodiment, the transportation device 100 includes one supporting component 1, which is substantially a plate-like structure extending along the first. horizontal direction X and the second horizontal direction Y. In another embodiment, the transportation device 100 includes two supporting components 1, and the supporting components 1 extend along the second horizontal direction Y and are spaced apart from each other in the first horizontal direction X.

In one embodiment, the transportation device 100 includes more than two supporting components 1. The transportation device 100 further includes two connecting components 3 for connecting the supporting components 1. In this embodiment, the supporting component 1 extend along the first horizontal direction X, the connecting components 3 extend along the second horizontal direction Y, and the connecting components 3 vertically connect the two supporting components 1.

The glass substrate cartridges 200 include at least two supporting hats 201 arranged in a bottom of the glass substrate cartridges 200. The supporting bars 201 extend along the second horizontal direction Y and are spaced apart from each other in the first horizontal direction X. Each of the supporting bars 201 is gripped by at least one pair of positioning components 2.

In the embodiment, each of the supporting bars 201 is gripped by the two positioning components 2. The positioning components 2 for gripping, the same supporting bar 201 are respectively arranged on different supporting component 1. A top surface of the supporting component 1 is a hearing surface 10. The positioning components 2 are arranged on the bearing surface 10. Each pair of the positioning components 2 are spaced apart from each other along in the first horizontal direction X. In addition, each pair of the positioning components 2 elastically grips the supporting bars 201 of the glass substrate cartridges 200.

In one embodiment, the number of the positioning components 2 for gripping one supporting bars 201, and the number of the supporting bars 201 are not limited in the disclosure. In other embodiments, the glass substrate cartridges 200 may not include the supporting bars 201. For example, at least one pair of positioning components 2 elastically grip two opposite sides of the glass substrate cartridges 200.

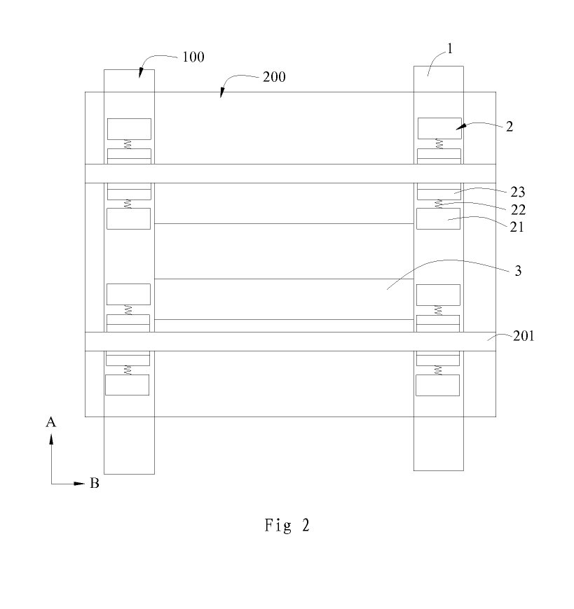

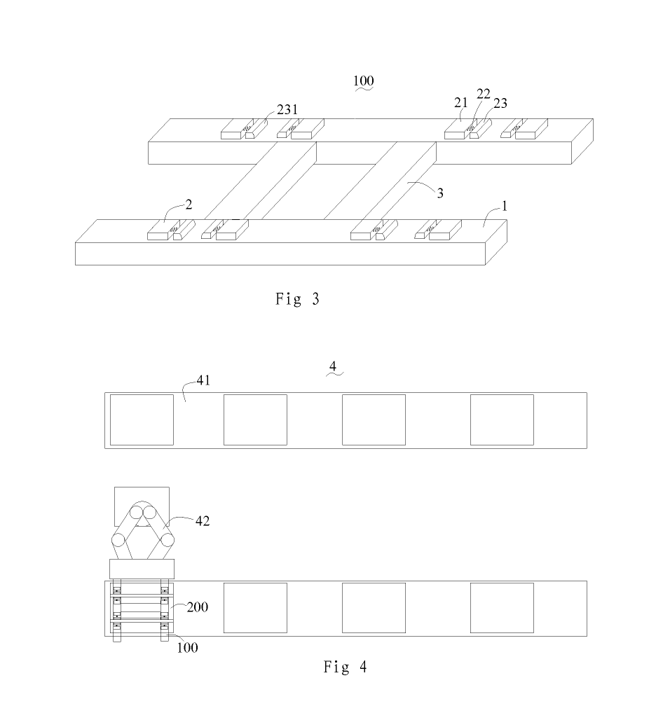

Also referring to FIGS. 2 and 3, each of the positioning components 2 includes a fixing assembly 21, an elastic assembly 22 and a sliding assembly 23 arranged on the supporting component 1. The fixing assembly 21 is fixed on the hearing surface 10 of the supporting component 1. The sliding assembly 23 is capable of sliding along the first horizontal direction X in accordance with the supporting component 1. The elastic assembly 22 is arranged between the fixing assembly 21 and the sliding assembly 23. In addition, the elastic assembly 22 connects the sliding assembly 23 and the fixing assembly 21 so that the sliding assembly 23 elastically supported on the gripped side of the supporting bars 201.

In other words, for one pair of the positioning components 2, the sliding assembly 23 are spaced apart and arranged close to the other, and the fixing assembly 21 are arranged to be distant from the other.

The sliding assembly 23 includes a guiding portion 231 to smoothly access the glass substrate cartridges 200. Preferably, the guiding portion 231 includes an arc-connected surface. The guiding portion 211 is for guiding the glass substrate cartridges 200 to be carried on the supporting component 1 along a vertical direction. The guiding portion 231 guides the supporting bars 201 to slide into one location between one pair of positioning components 2 and were elastically gripped by one pair of positioning components 2.

In one embodiment, the elastic assembly 22 is a spring. In other embodiments, the elastic assembly 22 may be components made of elastic materials. In addition, the elastic assembly 22 may be integrally formed with the sliding assembly 23 on condition that the positioning components 2 contacts with portions of the supporting bars 201 or the glass substrate cartridges 200.

FIG. 4 shows a warehouse apparatus 4 in accordance with one embodiment. The warehouse apparatus 4 includes a cabinet 41, lifting arms 42, and the transportation device 100. The transportation device 100 connects with the lifting arms 42 and is driven by the lifting arms 42 to move the glass substrate cartridges 200 into the cabinet 41 or to move the glass substrate cartridges 200 out from the cabinet 41.

The glass substrate cartridges 200 elastically contacts with the positioning components 2 when the transportation device 100 carries the glass substrate cartridges 200. As such, the glass substrates within the glass substrate cartridges 200 are not displaced or fragmented due to the buffering effect between the glass substrate cartridges 200 and the positioning components 2.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A transportation device of glass substrate cartridges, comprising:
at least two supporting components for bearing the glass substrate cartridges, the two supporting components extend along a first horizontal direction and are spaced apart from each other in a second horizontal direction, wherein the second horizontal direction is vertical to the first horizontal direction;
at least one pair of positioning components arranged on the supporting component, the positioning components extend along the first horizontal direction and are spaced apart from each other, and the at least one pair of positioning components elastically position the glass substrate cartridges along the first horizontal direction; and
connecting components extend along the second horizontal direction and connect the at least two supporting components.

2. The transportation device as claimed in claim 1, wherein the glass substrate cartridges comprises at least two supporting bars arranged in a bottom of the glass substrate cartridges, the supporting bars extend along the second horizontal direction and are spaced apart from each other in the first horizontal direction, and each pair of the positioning components elastically grip two opposite sides of the supporting bars along the first horizontal direction.

3. The transportation device as claimed in claim 2, wherein the positioning components comprise a fixing assembly, an elastic assembly and a sliding assembly arranged on the supporting component along the first horizontal direction, the fixing assembly is fixed on the supporting component, the sliding assembly is capable of sliding along with the supporting component, and the elastic assembly is arranged between the fixing assembly and the sliding assembly so that the sliding assembly is elastically supported on the gripped side of the supporting bars.

4. The transportation device as claimed in claim 3, wherein the sliding assembly comprises a guiding portion for guiding the glass substrate cartridges to be carried on the supporting component along a vertical direction.

5. The transportation device as claimed in claim 4, wherein the guiding portion includes an arc-connected surface.

6. The transportation device as claimed in claim 3, wherein the elastic assembly is a spring.

7. A transportation device of glass substrate cartridges, comprising:
at least one supporting component for bearing the glass substrate cartridges; and
at least one pair of positioning components arranged on the supporting component, and the positioning components elastically position the glass substrate cartridges along a horizontal direction.

8. The transportation device as claimed in claim 7, wherein the transportation device comprises at least two supporting components extending along a first horizontal direction and are spaced apart from each other in a second horizontal direction, wherein the second horizontal direction is vertical to the first horizontal direction, and the positioning components elastically position the glass substrate cartridges along the first horizontal direction.

9. The transportation device as claimed in claim 8, wherein the transportation device comprises at least one pair of positioning components extending along the first horizontal direction, the positioning components are spaced apart from each other, and each pair of positioning components elastically position the glass substrate cartridges along the first horizontal direction.

10. The transportation device as claimed in claim 9, wherein the glass substrate cartridges comprise at least two supporting bars arranged in a bottom of the glass substrate cartridges, the supporting bars extend along the second horizontal direction and are spaced apart from each other in the first horizontal direction, and each pair of the positioning components elastically grip two opposite sides of the supporting bars along the first horizontal direction.

11. The transportation device as claimed in claim 10, wherein the positioning components comprise a fixing assembly, an elastic assembly and a sliding assembly arranged on the supporting component along the first horizontal direction, the fixing assembly is fixed on the supporting component, the sliding assembly is capable of sliding along with the supporting component, and the elastic assembly is arranged between the fixing assembly and the sliding assembly so that the sliding assembly is elastically supported on the gripped side of the supporting bars.

12. The transportation device as claimed in claim 11, wherein the sliding assembly comprises a guiding portion for guiding the glass substrate cartridges to be carried on the supporting component along a vertical direction.

13. The transportation device as claimed in claim 12, wherein the guiding portion includes an arc-connected surface.

14. The transportation device as claimed in claim 11, wherein the elastic assembly is a spring.

15. The transportation device as claimed in claim 8, wherein the transportation device further comprises connecting components extending along the second horizontal direction and connecting the at least two supporting components.

16. A warehouse apparatus, comprising:
a cabinet, lifting arms, and a transportation device comprising at least one supporting component and at least one pair of positioning components arranged on the supporting component, the at least one supporting component is for bearing the glass substrate cartridges, and the at least one pair of positioning components is for elastically positioning the glass substrate cartridges along a horizontal direction; and
the transportation device connects with the lifting and is driven by the lifting arms to move the glass substrate cartridges into the cabinet or to move glass substrate cartridges out from the cabinet.
